(19) United States
(12) Patent Application Publication
(10) Pub. No.: US 2016/0326357 A1
(43) Pub. Date: Nov. 10, 2016

(54) Compositions Comprising Propylene-Based Elastomers and Polyalphaolefins

(71) Applicant: EXXONMOBIL CHEMICAL PATENTS INC., Baytown, TX (US)

(72) Inventors: Narayanaswami R. DHARMARAJAN, Houston, TX (US); Paul E. ROLLIN Jr., Porter, TX (US); Andy H. TSOU, Houston, TX (US)

(21) Appl. No.: 15/109,940

(22) PCT Filed: Aug. 20, 2014
(86) PCT No.: PCT/US2014/051870

§ 371 Date: Jul. 6, 2016

Related U.S. Application Data
(60) Provisional application No. 61/945,612, filed on Feb. 27, 2014.

(51) Int. Cl. C08L 23/14; B32B 27/12; B32B 5/02; B32B 27/32; C08J 5/18; B32B 5/24

(52) U.S. Cl. CPC C08L 23/14; C08J 5/18; B32B 5/24; B32B 5/022; B32B 27/32; B32B 27/12; C08J 2323/14; C08J 2423/02

(57) ABSTRACT

Provided are compositions comprising a propylene-based elastomer and a polyalphaolefin. The compositions may be particularly useful in elastic film compositions, and especially useful as elastic film layers in nonwoven laminates. The composition may comprise a blend of from about 0.5 to about 60 wt % of a polyalphaolefin and 40 to 99.5 wt % of a propylene-based elastomer. The composition may comprise a blend of a propylene-based elastomer that comprises propylene and from 5 to 30 wt % of an α-olefin and a polyalphaolefin having a kinematic viscosity (KV) at 100° C. of from 100 to 3000 cSt.

### CROSS REFERENCE TO RELATED APPLICATIONS

This application claims the benefit of and priority to U.S. Provisional Application No. 61/945,612, filed Feb. 27, 2014, the disclosure of which is incorporated herein by reference.

This application is related to U.S. Provisional Application No. 61/884,484, filed Sep. 30, 2013, the disclosure of which is incorporated herein by reference.

### FIELD OF THE INVENTION

This invention relates to compositions comprising propylene-based elastomers and polyalphaolefins and to articles made therefrom.

### BACKGROUND OF THE INVENTION

Propylene-based polymers and copolymers (sometimes referred to as propylene-based elastomers) are well known in the art for their usefulness in a variety of applications, including the manufacture of films and nonwoven fabrics. Such films and fabrics have a wide variety of uses, such as in medical and hygiene products. Many medical and hygiene products, such as diaper waist bands, leg cuffs, and elastic stretch engines, are constructed from elastic laminates. The elastic laminates may comprise outer facing layers that provide aesthetic feel and inner core layers that provide the laminate with elastic properties.

In such elastic laminates, the extensibility of the laminate is typically governed to a large extent by the properties of the elastic layer, which may be a nonwoven or film layer. For diaper applications there is a customer preference for a soft-stretch, where the laminate when extended shows a load that increases initially but remains relatively unchanged with additional extension. For example, soft-stretch laminates are particularly desirable for infant diaper applications, so that when an adult fastens the diaper on the infant they will not need to apply a high force to extend the elastic laminate.

Examples of elastic laminates include an inner film layer of an elastic styrenic block copolymer (SBC) compound laminated between facing layers of polypropylene based nonwoven fabrics. However, in such laminates the SBC layer is relatively incompatible with the PP facing layer. Therefore, adhesive tie layers are often needed to provide a good bond between the facing layers and the inner layer. However, adhesive tie layers increase the complexity of the lamination process and add overall cost to the production process.

Laminate compositions have also been made that include an inner film layer of a propylene-based polymer. However, while more compatible with propylene-based outer layers than SBC film layers, such film layers often do not possess the desired soft-stretch. For example, U.S. Pat. No. 7,998,579 describes fibers and nonwovens made from plasticized polyolefin compositions comprising a polyolefin, a non-functionalized hydrocarbon plasticizer, and a slip agent.

Other background references include U.S. Pat. Nos. 7,122,584; 7,335,696; 7,645,829; 7,662,885; and 7,951,732; U.S. Publication Nos. 2006/0135699; 2009/0043049; 2013/0053479; and 2013/0281596; U.S. Provisional Patent Application No. 61/857,352; EP Publication No. 0964890; and PCT Publication Nos. WO 2006/118807 and WO 2009/035579.

While the above references provide a variety of different polymers, fabrics, and films, none provide for an elastic laminate having the desired soft-stretch. Therefore, there is a need for elastic laminates having good soft-stretch and elasticity constructed from compatible inner layer films and outer facing layers.

### BRIEF DESCRIPTION OF THE FIGURES

FIG. 1 illustrates the first-cycle hysteresis curve of blends in the Examples.

FIG. 2 is an Atomic Force Microscopy (AFM) picture of a blend of propylene-based elastomer and 10 wt % of 10 cSt polyalphaolefin.

FIG. 3 is an AFM picture of a blend of a propylene-based elastomer and 10 wt % of 1000 cSt polyalphaolefin.

### SUMMARY OF THE INVENTION

Provided herein are compositions comprising propylene-based elastomers and polyalphaolefins. The compositions may be particularly useful in elastic film compositions and in elastic nonwoven compositions.

The composition comprises a propylene-based elastomer (“PBE”), where the PBE comprises propylene-derived units and 5 to 30 wt % of α-olefin derived units. The PBE may have a melting point of less than 120° C. and a heat of fusion of less than 75 J/g.

In some embodiments, the PBE may be a reactor blend of a first polymer component and a second polymer component, wherein the first polymer component comprises propylene and an α-olefin and has an α-olefin content R₁ of from greater than 5 to less than 30 wt % α-olefin, where the percentage by weight is based upon the total weight of the propylene-derived and α-olefin derived units of the first polymer component, and wherein the second polymer component comprises propylene and α-olefin and has an α-olefin content R₂ of from greater than 1 to less than 10 wt % α-olefin, where the percentage by weight is based upon the total weight of the propylene-derived and α-olefin derived units of the second polymer component.

In addition to the PBE, the composition comprises from about 0.5 to about 60 wt % of a polyalphaolefin (“PAO”), where the PAO has a kinematic viscosity (KV) at 100° C. of from 100 to 3000 cSt.

The composition comprising the PBE and the PAO may have at least one of the following properties:
(i) a first cycle hysteresis top load at 50% strain of less than 25N;
(ii) a first cycle hysteresis top load at 100% strain of less than 30N;
(iii) a first cycle hysteresis retractive force at 50% strain of less than 15N;
(iv) a first cycle hysteresis top load at 50% strain that is at least 15% lower than a similar composition containing the same PBE but that contains no PAO;
(v) a second cycle hysteresis top load at 100% strain of less than 30N;
(vi) a second cycle hysteresis retractive force at 50% strain of less than 12N; or
(vii) a first cycle hysteresis top load at 50% strain that is at least 15% lower than a similar composition containing the same propylene-based elastomer but that contains no polyalphaolefin.

Also described herein are films and nonwoven fabrics comprising the blend composition of the PBE and the PAO.

### DETAILED DESCRIPTION OF THE INVENTION

Described herein are compositions comprising propylene-based elastomers and polyalphaolefins. The compositions may be useful in making films, fibers, and nonwoven laminates and composites. In particular, the compositions may be useful in making elastic films and nonwovens for hygiene laminate applications.

As used herein, the term “copolymer” is meant to include polymers having two or more monomers, optionally, with other monomers, and may refer to interpolymers, terpolymers, etc. The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic and random symmetries. The term “elastomer” shall mean any polymer exhibiting some degree of elasticity, where elasticity is the ability of a material that has been deformed by a force (such as by stretching) to return at least partially to its original dimensions once the force has been removed.

The term “monomer” or “comonomer,” as used herein, can refer to the monomer used to form the polymer, i.e., the unreacted chemical compound in the form prior to polymerization, and can also refer to the monomer after it has been incorporated into the polymer, also referred to herein as a “[monomer]-derived unit”.

“Polypropylene,” as used herein, includes homopolymers and copolymers of propylene or mixtures thereof. Products that include one or more propylene monomers polymerized with one or more additional monomers may be more commonly known as random copolymers (RCP) or impact copolymers (ICP). Impact copolymers may also be known in the art as heterophasic copolymers. “Propylene-based,” as used herein, is meant to include any polymer comprising propylene, either alone or in combination with one or more comonomers, in which propylene is the major component (i.e., greater than 50 wt % propylene).

“Reactor grade,” as used herein, means a polymer that has not been chemically or mechanically treated or blended after polymerization in an effort to alter the polymer's average molecular weight, molecular weight distribution, or viscosity. Particularly excluded from those polymers described as reactor grade are those that have been visbroken or otherwise treated or coated with peroxide or other prodegradants. For the purposes of this disclosure, however, reactor grade polymers include those polymers that are reactor blends.

“Reactor blend,” as used herein, means a highly dispersed and mechanically inseparable blend of two or more polymers produced in situ as the result of sequential or parallel polymerization of one or more monomers with the formation of one polymer in the presence of another in series reactors, or by solution blending polymers made separately in parallel reactors. Reactor blends may be produced in a single reactor, a series of reactors, or parallel reactors and are reactor grade blends. Reactor blends may be produced by any polymerization method, including batch, semi-continuous, or continuous systems. Particularly excluded from “reactor blend” polymers are blends of two or more polymers in which the polymers are blended ex situ, such as by physically or mechanically blending in a mixer, extruder, or other similar device.

“Visbreaking,” as used herein, is a process for reducing the molecular weight of a polymer by subjecting the polymer to chain scission. The visbreaking process also increases the MFR of a polymer and may narrow its molecular weight distribution. Several different types of chemical reactions can be employed for visbreaking propylene-based polymers. An example is thermal pyrolysis, which is accomplished by exposing a polymer to high temperatures, e.g., in an extruder at 270° C. or higher. Other approaches are exposure to powerful oxidizing agents and exposure to ionizing radiation. Another method of visbreaking is the addition of a prodegradant to the polymer. A prodegradant is a substance that promotes chain scission when mixed with a polymer, which is then heated under extrusion conditions. Examples of prodegradants that may be used include peroxides, such as alkyl hydroperoxides and dialkyl peroxides. These materials, at elevated temperatures, initiate a free radical chain reaction resulting in scission of polypropylene molecules. The terms “prodegradant” and “visbreaking agent” are used interchangeably herein. Polymers that have undergone chain scission via a visbreaking process are said herein to be “visbroken.” Such visbroken polymer grades, particularly polypropylene grades, are often referred to in the industry as “controlled rheology” or “CR” grades.

“Catalyst system,” as used herein, means the combination of one or more catalysts with one or more activators and, optionally, one or more support compositions. An “activator” is any compound(s) or component(s) capable of enhancing the ability of one or more catalysts to polymerize monomers to polymers.

As used herein, “nonwoven fabric” means a web structure of individual fibers or filaments that are interlaid, but not in an identifiable manner as in a knitted fabric.

### Propylene-Based Elastomers

The compositions described herein comprise one or more propylene-based elastomers (“PBEs”). The PBE comprises propylene and from about 5 to about 30 wt % of one or more alpha-olefin derived units, preferably ethylene and/or C₄-C₁₂ α-olefins. For example, the alpha-olefin derived units, or comonomer, may be ethylene, butene, pentene, hexene, 4-methyl-1-pentene, octene, or decene. In preferred embodiments, the comonomer is ethylene. In some embodiments, the PBE consists essentially of propylene and ethylene, or consists only of propylene and ethylene. Some of the embodiments described below are discussed with reference to ethylene as the comonomer, but the embodiments are equally applicable to PBEs with other α-olefin comonomers. In this regard, the copolymers may simply be referred to as propylene-based elastomers with reference to ethylene as the α-olefin.

The PBE may include at least about 5 wt %, at least about 6 wt %, at least about 7 wt %, at least about 8 wt %, at least about 9 wt %, at least about 10 wt %, at least about 12 wt %, or at least about 15 wt %, α-olefin-derived units, where the percentage by weight is based upon the total weight of the propylene-derived and α-olefin-derived units. The PBE may include up to about 30 wt %, up to about 25 wt %, up to about 22 wt %, up to about 20 wt %, up to about 19 wt %, up to about 18 wt %, or up to about 17 wt %, α-olefin-derived units, where the percentage by weight is based upon the total weight of the propylene-derived and α-olefin-derived units. In some embodiments, the PBE may comprise from about 5 wt % to about 30 wt %, from about 6 wt % to about 25 wt %, from about 7 wt % to about 20 wt %, from about 10 wt % to about 19 wt %, from about 12 wt % to about 18 wt %, or from about 15 wt % to about 17 wt %, α-olefin-derived units, where the percentage by weight is based upon the total weight of the propylene-derived and α-olefin-derived units.

The PBE may include at least about 70 wt %, at least about 75 wt %, at least about 78 wt %, at least about 80 wt %, at least about 81 wt %, at least about 82 wt %, or at least about 83 wt %, propylene-derived units, where the percentage by weight is based upon the total weight of the propylene-derived and α-olefin derived units. The PBE may include up to about 95 wt %, up to about 94 wt %, up to about 93 wt %, up to about 92 wt %, up to about 91 wt %, up to about 90 wt %, up to about 88 wt %, or up to about 85 wt %, propylene-derived units, where the percentage by weight is based upon the total weight of the propylene-derived and α-olefin derived units.

The PBEs may be characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak. The Tm of the PBE (as determined by DSC) may be less than about 120° C., less than about 115° C., less than about 110° C., or less than about 105° C.

The PBE may be characterized by its heat of fusion (Hf), as determined by DSC. The PBE may have an Hf that is at least about 0.5 J/g, at least about 1.0 J/g, at least about 1.5 J/g, at least about 3.0 J/g, at least about 4.0 J/g, at least about 5.0 J/g, at least about 6.0 J/g, or at least about 7.0 J/g. The PBE may be characterized by an Hf of less than about 75 J/g, or less than about 70 J/g, or less than about 60 J/g, or less than about 50 J/g.

As used within this specification, DSC procedures for determining Tm and Hf are as follows. The polymer is pressed at a temperature of from about 200° C. to about 230° C. in a heated press, and the resulting polymer sheet is hung, under ambient conditions, in the air to cool. About 6 to 10 mg of the polymer sheet is removed with a punch die. This 6 to 10 mg sample is annealed at room temperature for about 80 to 100 hours. At the end of this period, the sample is placed in a DSC (Perkin Elmer Pyris One Thermal Analysis System) and cooled to about −30° C. to about −50° C. and held for 10 minutes at that temperature. The sample is then heated at 10° C./min to attain a final temperature of about 200° C. The sample is kept at 200° C. for 5 minutes. Then a second cool-heat cycle is performed, where the sample is again cooled to about −30° C. to about −50° C. and held for 10 minutes at that temperature, and then re-heated at 10° C./min to a final temperature of about 200° C. Events from both cycles are recorded. The thermal output is recorded as the area under the melting peak of the sample, which typically occurs between about 0° C. and about 200° C. It is measured in Joules and is a measure of the Hf of the polymer.

The PBE can have a triad tacticity of three propylene units (mmm tacticity), as measured by ¹³C NMR, of 75% or greater, 80% or greater, 85% or greater, 90% or greater, 92% or greater, 95% or greater, or 97% or greater. For example, the triad tacticity may range from about 75 to about 99%, from about 80 to about 99%, from about 85 to about 99%, from about 90 to about 99%, from about 90 to about 97%, or from about 80 to about 97%. Triad tacticity may be determined by the methods described in U.S. Pat. No. 7,232,871.

The PBE may have a tacticity index m/r ranging from a lower limit of 4 or 6 to an upper limit of 8 or 10 or 12. The tacticity index, expressed herein as “m/r”, is determined by ¹³C nuclear magnetic resonance (“NMR”). The tacticity index, m/r, is calculated as defined by H. N. Cheng in Vol. 17, MACROMOLECULES, pp. 1950-1955 (1984), incorporated herein by reference. The designation “m” or “r” describes the stereochemistry of pairs of contiguous propylene groups, “m” referring to meso, and “r” to racemic. An m/r ratio of 1.0 generally describes a syndiotactic polymer, and an m/r ratio of 2.0 describes an atactic material.

The PBE may have a percent crystallinity of from about 0.5% to about 40%, from about 1% to about 30%, or from about 5% to about 25%, determined according to DSC procedures. Crystallinity may be determined by dividing the Hf of a sample by the Hf of a 100% crystalline polymer, which is assumed to be 189 J/g for isotactic polypropylene.

The PBE may have a density of from about 0.84 g/cm³ to about 0.92 g/cm³, from about 0.85 g/cm³ to about 0.90 g/cm³, or from about 0.85 g/cm³ to about 0.87 g/cm³ at room temperature, as measured per the ASTM D-1505 test method.

The PBE can have a melt index (MI) (ASTM D-1238, 2.16 kg @ 190° C.), of less than or equal to about 100 g/10 min, less than or equal to about 50 g/10 min, less than or equal to about 25 g/10 min, less than or equal to about 10 g/10 min, less than or equal to about 8.0 g/10 min, less than or equal to about 5.0 g/10 min, or less than or equal to about 3.0 g/10 min.

The PBE may have a melt flow rate (MFR), as measured according to ASTM D-1238 (2.16 kg weight @ 230° C.), greater than about 0.5 g/10 min, greater than about 1.0 g/10 min, greater than about 1.5 g/10 min, greater than about 2.0 g/10 min, or greater than about 2.5 g/10 min. The PBE may have an MFR less than about 100 g/10 min, less than about 50 g/10 min, less than about 25 g/10 min, less than about 15 g/10 min, less than about 10 g/10 min, less than about 7 g/10 min, or less than about 5 g/10 min. In some embodiments, the PBE may have an MFR from about 0.5 to about 10 g/10 min, from about 1.0 to about 7 g/10 min, or from about 1.5 to about 5 g/10 min.

The PBE may have a g′ index value of 0.95 or greater, or at least 0.97, or at least 0.99, wherein g′ is measured at the Mw of the polymer using the intrinsic viscosity of isotactic polypropylene as the baseline. For use herein, the g′ index is defined as:

$${g}^{′} = \frac{{η}_{b}}{{η}_{l}}$$

where ηb is the intrinsic viscosity of the polymer and ηl is the intrinsic viscosity of a linear polymer of the same viscosity-averaged molecular weight (Mv) as the polymer. ηl=KMvα, K and α are measured values for linear polymers and should be obtained on the same instrument as the one used for the g′ index measurement.

The PBE may have a weight average molecular weight (Mw), as measured by DRI, of from about 50,000 to about 1,000,000 g/mol, or from about 75,000 to about 500,000 g/mol, from about 100,000 to about 350,000 g/mol, from about 125,000 to about 300,000 g/mol, from about 150,000 to about 275,000 g/mol, or from about 200,000 to about 250,000 g/mol.

The PBE may have a number average molecular weight (Mn), as measured by DRI, of from about 5,000 to about 500,000 g/mol, from about 10,000 to about 300,000 g/mol, from about 50,000 to about 250,000 g/mol, from about 75,000 to about 200,000 g/mol, or from about 100,000 to about 150,000 g/mol.

The PBE may have a z-average molecular weight (Mz), as measured by MALLS, of from about 50,000 to about 1,000,000 g/mol, or from about 75,000 to about 500,000 g/mol, or from about 100,000 to about 400,000 g/mol, from about 200,000 to about 375,000 g/mol, or from about 250,000 to about 350,000 g/mol.

The molecular weight distribution (MWD, equal to Mw/Mn) of the PBE may be from about 0.5 to about 20, from about 0.75 to about 10, from about 1.0 to about 5, from about 1.5 to about 4, or from about 1.8 to about 3.

Optionally, the PBE may also include one or more dienes. The term “diene” is defined as a hydrocarbon compound that has two unsaturation sites, i.e., a compound having two double bonds connecting carbon atoms. Depending on the context, the term “diene” as used herein refers broadly to either a diene monomer prior to polymerization, e.g., forming part of the polymerization medium, or a diene monomer after polymerization has begun (also referred to as a diene monomer unit or a diene-derived unit). In some embodiments, the to diene may be selected from 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopentadiene (DCPD), and combinations thereof. In embodiments where the propylene-based elastomer composition comprises a diene, the diene may be present at from 0.05 wt % to about 6 wt %, from about 0.1 wt % to about 5.0 wt %, from about 0.25 wt % to about 3.0 wt %, from about 0.5 wt % to about 1.5 wt %, diene-derived units, where the percentage by weight is based upon the total weight of the propylene-derived, α-olefin derived, and diene-derived units.

Optionally, the PBE may be grafted (i.e., “functionalized”) using one or more grafting monomers. As used herein, the term “grafting” denotes covalent bonding of the grafting monomer to a polymer chain of the PBE. The grafting monomer can be or include at least one ethylenically unsaturated carboxylic acid or acid derivative, such as an acid anhydride, ester, salt, amide, imide, or acrylates. Illustrative grafting monomers include, but are not limited to, acrylic acid, methacrylic acid, maleic acid, fumaric acid, itaconic acid, citraconic acid, mesaconic acid, maleic anhydride, 4-methyl cyclohexene-1,2-dicarboxylic acid anhydride, bicyclo(2.2.2)octene-2,3-dicarboxylic acid anhydride, 1,2,3,4,5,8,9,10-octahydronaphthalene-2,3-dicarboxylic acid anhydride, 2-oxa-1,3-diketospiro(4.4)nonene, bicyclo(2.2.1)heptene-2,3-dicarboxylic acid anhydride, maleopimaric acid, tetrahydrophthalic anhydride, norbornene-2,3-dicarboxylic acid anhydride, nadic anhydride, methyl nadic anhydride, himic anhydride, methyl himic anhydride, and 5-methylbicyclo(2.2.1)heptene-2,3-dicarboxylic acid anhydride. Other suitable grafting monomers include methyl acrylate and higher alkyl acrylates, methyl methacrylate and higher alkyl methacrylates, acrylic acid, methacrylic acid, hydroxy-methyl methacrylate, hydroxyl-ethyl methacrylate and higher hydroxy-alkyl methacrylates and glycidyl methacrylate. Maleic anhydride is a preferred grafting monomer. In embodiments wherein the graft monomer is maleic anhydride, the maleic anhydride concentration in the grafted polymer is preferably in the range of about 1 to about 6 wt %, at least about 0.5 wt %, or at least about 1.5 wt %.

In some embodiments, the PBE is a reactor blended polymer, as defined herein. That is, the PBE is a reactor blend of a first polymer component and a second polymer component. Thus, the comonomer content of the propylene-based elastomer can be adjusted by adjusting the comonomer content of the first polymer component, adjusting the comonomer content of second polymer component, and/or adjusting the ratio of the first polymer component to the second polymer component present in the PBE.

In embodiments where the PBE is a reactor blended polymer, the α-olefin content of the first polymer component (“R₁”) may be greater than 5 wt % α-olefin, greater than 7 wt % α-olefin, greater than 10 wt % α-olefin, greater than 12 wt % α-olefin, greater than 15 wt % α-olefin, or greater than 17 wt % α-olefin, where the percentage by weight is based upon the total weight of the propylene-derived and α-olefin-derived units of the first polymer component. The α-olefin content of the first polymer component may be less than 30 wt % α-olefin, less than 27 wt % α-olefin, less than 25 wt % α-olefin, less than 22 wt % α-olefin, less than 20 wt % α-olefin, or less than 19 wt % α-olefin, where the percentage by weight is based upon the total weight of the propylene-derived and α-olefin-derived units of the first polymer component. In some embodiments, the α-olefin content of the first polymer component may range from 5 wt % to 30 wt % α-olefin, from 7 wt % to 27 wt % α-olefin, from 10 wt % to 25 wt % α-olefin, from 12 wt % to 22 wt % α-olefin, from 15 wt % to 20 wt % α-olefin, or from 17 wt % to 19 wt % α-olefin. Preferably, the first polymer component comprises propylene and ethylene, and in some embodiments the first polymer component consists only of propylene and ethylene derived units.

In embodiments where the PBE is a reactor blended polymer, the α-olefin content of the second polymer component (“R₂”) may be greater than 1.0 wt % α-olefin, greater than 1.5 wt % α-olefin, greater than 2.0 wt % α-olefin, greater than 2.5 wt % α-olefin, greater than 2.75 wt % α-olefin, or greater than 3.0 wt % α-olefin, where the percentage by weight is based upon the total weight of the propylene-derived and α-olefin-derived units of the second polymer component. The α-olefin content of the second polymer component may be less than 10 wt % α-olefin, less than 9 wt % α-olefin, less than 8 wt % α-olefin, less than 7 wt % α-olefin, less than 6 wt % α-olefin, or less than 5 wt % α-olefin, where the percentage by weight is based upon the total weight of the propylene-derived and α-olefin -derived units of the second polymer component. In some embodiments, the α-olefin content of the second polymer component may range from 1.0 wt % to 10 wt % α-olefin, or from 1.5 wt % to 9 wt % α-olefin, or from 2.0 wt % to 8 wt % α-olefin, or from 2.5 wt % to 7 wt % α-olefin, or from 2.75 wt % to 6 wt % α-olefin, or from 3 wt % to 5 wt % α-olefin. Preferably, the second polymer component comprises propylene and ethylene, and in some embodiments the first polymer component consists only of propylene and ethylene derived units.

In embodiments where the PBE is a reactor blended polymer, the PBE may comprise from 1 to 25 wt % of the second polymer component, from 3 to 20 wt % of the second polymer component, from 5 to 18 wt % of the second polymer component, from 7 to 15 wt % of the second polymer component, or from 8 to 12 wt % of the second polymer component, based on the weight of the propylene-based elastomer. The PBE may comprise from 75 to 99 wt % of the first polymer component, from 80 to 97 wt % of the first polymer component, from 85 to 93 wt % of the first polymer component, or from 82 to 92 wt % of the first polymer component, based on the weight of the propylene-based elastomer.

### Preparation of Propylene-Based Elastomers

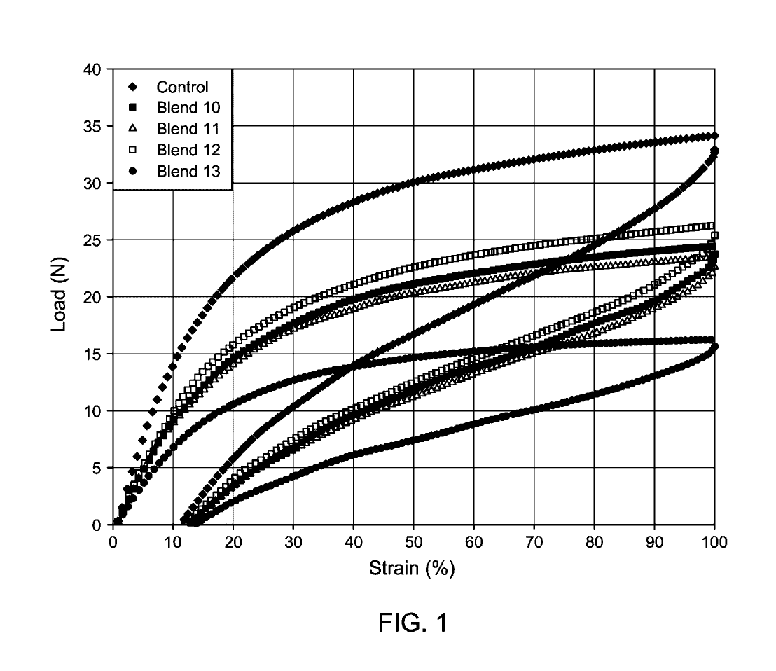

The PBE may be prepared by any suitable means as known in the art. For example, the PBE may be prepared by reacting monomers in the presence of a catalyst system as described herein at a temperature of from 0° C. to 200° C. for a time of from 1 second to 10 hours. Preferably, homogeneous conditions are used, such as a continuous solution polymerization process. Exemplary methods for the preparation of propylene-based elastomer may be found in U.S. Pat. Nos. 6,881,800; 7,803,876; 8,013,069; and 8,026,323 and PCT Publication Nos. WO 2011/087729; WO 2011/087730; and WO 2011/087731. For example, the propylene-based elastomer may be prepared in a continuous solution polymerization process such as that described in FIG. 1 of U.S. Pat. No. 6,881,800, where the reactors (8) are arranged in a parallel configuration or in a series configuration. In preferred embodiments, the propylene-based elastomer is prepared in a continuous solution polymerization process that utilizes two polymerization reactors arranged in a parallel configuration.

The triad tacticity and tacticity index of the PBE may be controlled by the catalyst, which influences the stereoregularity of propylene placement, the polymerization temperature, according to which stereoregularity can be reduced by increasing the temperature, and by the type and amount of a comonomer, which tends to reduce the level of longer propylene derived sequences. The comonomer content and sequence distribution of the polymers can be measured using ¹³C nuclear magnetic resonance (NMR) by methods well known to those skilled in the art. Comonomer content of discrete molecular weight ranges can be measured using methods well known to those skilled in the art, including Fourier Transform Infrared Spectroscopy (FTIR) in conjunction with samples by GPC, as described in Wheeler and Willis, Applied Spectroscopy, 1993, Vol. 47, pp. 1128-1130. For a propylene ethylene copolymer containing greater than 75 wt % propylene, the comonomer content (ethylene content) of such a polymer can be measured as follows: A thin homogeneous film is pressed at a temperature of about 150° C. or greater, and mounted on a Perkin Elmer PE 1760 infrared spectrophotometer. A full spectrum of the sample from 600 cm-1 to 4000 cm-1 is recorded and the monomer weight percent of ethylene can be calculated according to the following equation: Ethylene wt %=82.585−111.987X+30.045X2, where X is the ratio of the peak height at 1155 cm-1 and peak height at either 722 cm-1 or 732 cm-1, whichever is higher. For propylene ethylene copolymers having 75 wt % or less propylene content, the comonomer (ethylene) content can be measured using the procedure described in Wheeler and Willis. Reference is made to U.S. Pat. No. 6,525,157 which contains more details on GPC measurements, the determination of ethylene content by NMR and the DSC measurements.

The catalyst may also control the stereoregularity in combination with the comonomer and the polymerization temperature. The PBEs described herein are prepared using one or more catalyst systems. As used herein, a “catalyst system” comprises at least a transition metal compound, also referred to as catalyst precursor, and an activator. Contacting the transition metal compound (catalyst precursor) and the activator in solution upstream of the polymerization reactor or in the polymerization reactor of the disclosed processes yields the catalytically active component (catalyst) of the catalyst system. Such catalyst systems may optionally include impurity scavengers.

The catalyst systems used for producing the PBE may comprise a metallocene compound. In some embodiments, the metallocene compound is a bridged bisindenyl metallocene having the general formula (In¹)Y(In²)MX₂, where In¹ and In² are the same or different, and are substituted or unsubstituted indenyl groups bound to M and bridged by Y, Y is a bridging group in which the number of atoms in the direct chain connecting In¹ with In² is from 1 to 8 and the direct chain comprises C or Si, and M is a Group 3, 4, 5, or 6 transition metal. In¹ and In² may be substituted or unsubstituted. If In¹ and In² are substituted by one or more substituents, the substituents are selected from the group consisting of a halogen atom, C₁ to C₁₀ alkyl, C₅ to C₁₅ aryl, C₆ to C₂₅ alkylaryl, and N- or P-containing alkyl or aryl. Exemplary metallocene compounds include, but are not limited to, μ-dimethyl-silylbis(indenyl)hafniumdimethyl, μ-dimethylsilylbis(indenyl)zirconiumdimethyl, (μ-dimethyl-silyl)bis(2-methyl-4-(3′,5′-di-tert-butylphenyl)indenyl)zirconiumdimethyl, (μ-dimethyl-silyl)bis(2-methyl-4-(3′,5′-di-tert-butylphenyl)indenyl)hafniumdimethyl, μ-dimethyl-silyl)bis(2-methyl-4-naphthylindenyl)zirconiumdimethyl, (μ-dimethyl-silyl)bis(2-methyl-4-naphthylindenyl)hafniumdimethyl, (μ-dimethyl-silyl)bis(2-methyl-4-(N-carbazyl)indenyl)-zirconiumdimethyl, and (μ-dimethyl-silyl)bis(2-methyl-4-(N-carbazyl)indenyl)-hafniumdimethyl. Alternatively, the metallocene compound may correspond to one or more of the formulas disclosed in U.S. Pat. No. 7,601,666.

The activators of the catalyst systems used to produce PBE may comprise a cationic component. In some embodiments, the cationic component has the formula [R¹R²R³AH]⁺, where A is nitrogen, R¹ and R² are together a —(CH₂)ₐ— group, where a is 3, 4, 5 or 6 and form, together with the nitrogen atom, a 4-, 5-, 6- or 7-membered non-aromatic ring to which, via adjacent ring carbon atoms, optionally, one or more aromatic or heteroaromatic rings may be fused, and R³ is C₁, C₂, C₃, C₄ or C₅ alkyl, or N-methylpyrrolidinium or N-methylpiperidinium. In other embodiments, the cationic component has the formula [RₙAH]⁺, where A is nitrogen, n is 2 or 3, and all R are identical and are C₁ to C₃ alkyl groups, such as, for example, trimethylammonium, trimethylanilinium, triethylammonium, dimethylanilinium, or dimethylammonium.

In one or more embodiments, the activators of the catalyst systems used to produce the PBE comprise an anionic component, [Y]⁻. In some embodiments, the anionic component is a non-coordinating anion (NCA), having the formula [B(R⁴)₄]⁻, where R⁴ is an aryl group or a substituted aryl group, of which the one or more substituents are identical or different and are selected from the group consisting of alkyl, aryl, a halogen atom, halogenated aryl, and haloalkylaryl groups. In one or more embodiments, the substituents are perhalogenated aryl groups, or perfluorinated aryl groups, including but not limited to perfluorophenyl, perfluoronaphthyl and perfluorobiphenyl.

Together, the cationic and anionic components of the catalysts systems described herein form an activator compound. In one or more embodiments, the activator may be N,N-dimethylanilinium-tetra(perfluorophenyl)borate, N,N-dimethylanilinium-tetra(perfluoronaphthyl)borate, N,N-dimethylanilinium-tetrakis(perfluoro-biphenyl)borate, N,N-dimethylanilinium-tetrakis(3,5-bis(trifluoromethyl)phenyl)borate, triphenylcarbenium-tetra(perfluorophenyl)borate, triphenylcarbenium-tetra(perfluoro-naphthyl)borate, triphenylcarbenium-tetrakis(perfluorobiphenyl)borate, or triphenylcarbenium-tetrakis(3,5-bis(trifluoromethyl)phenyl)borate.

Any catalyst system resulting from any combination of a metallocene compound, a cationic activator component, and an anionic activator component described above shall be considered to be explicitly disclosed herein and may be used in accordance with the present invention in the polymerization of one or more olefin monomers. Also, combinations of two different activators can be used with the same or different metallocene(s).

Further, the catalyst systems may contain, in addition to the transition metal compound and the activator described above, additional activators (co-activators) and/or scavengers. A co-activator is a compound capable of reacting with the transition metal complex, such that when used in combination with an activator, an active catalyst is formed. Co-activators include alumoxanes and aluminum alkyls.

In some embodiments, scavengers may be used to “clean” the reaction of any poisons that would otherwise react with the catalyst and deactivate it. Typical aluminum or boron alkyl components useful as scavengers are represented by the general formula R^{x}JZ₂ where J is aluminum or boron, R^{x} is a C₁-C₂₀ alkyl radical, for example, methyl, ethyl, propyl, butyl, pentyl, and isomers thereof, and each Z is independently R^{x} or a different univalent anionic ligand such as halogen (Cl, Br, I), alkoxide (OR^{x}) and the like. Exemplary aluminum alkyls include triethylaluminum, diethylaluminum chloride, ethylaluminum dichloride, tri-iso-butylaluminum, tri-n-octylaluminum, tri-n-hexylaluminum, trimethylaluminum and combinations thereof. Exemplary boron alkyls include triethylboron. Scavenging compounds may also be alumoxanes and modified alumoxanes including methylalumoxane and modified methylalumoxane.

### Polyalphaolefin

Polyalphaolefins (PAOs) are oligomers of α-olefins (also known as 1-olefins). A PAO may be characterized by any type of tacticity, including isotactic or syndiotactic and/or atactic, and by any degree of tacticity, including isotactic-rich or syndiotactic-rich or fully atactic. PAO liquids are described in, for example, U.S. Pat. Nos. 3,149,178; 4,827,064; 4,827,073; 5,171,908; and 5,783,531; and in SYNTHETIC LUBRICANTS AND HIGH-PERFORMANCE FUNCTIONAL FLUIDS, Leslie R. Rudnick & Ronald L. Shubkin, eds. (Marcel Dekker, 1999), pp. 3-52. PAOs are Group 4 compounds, as defined by the American Petroleum Institute (API).

Useful PAOs may be made by any suitable means known in the art. For example, the PAOs may be prepared by the oligomerization of an α-olefin in the presence of a polymerization catalyst, such as a Friedel-Crafts catalyst (including, for example, AlCl₃, BF₃, and complexes of BF₃ with water, alcohols, carboxylic acids, or esters), a coordination complex catalyst (including, for example, the ethylaluminum sesquichloride+TiCl₄ system), or a homogeneous or heterogeneous (supported) catalyst more commonly used to make polyethylene and/or polypropylene (including, for example, Ziegler-Natta catalysts, metallocene or other single-site catalysts, and chromium catalysts). Subsequent to the oligomerization, the PAO may be hydrogenated in order to reduce any residual unsaturation. PAOs may be hydrogenated to yield substantially (>99 wt %) paraffinic materials. The PAOs may also be functionalized to comprise, for example, esters, polyethers, polyalkylene glycols, and the like.

The percentage of carbons in chain-type paraffinic structures (C_{P}) is close to 100% (typically greater than 98% or even 99%) for PAOs.

In general, PAOs are high purity hydrocarbons with a paraffinic structure and a high-degree of side-chain branching. The PAO may have irregular branching or regular branching. The PAO may comprise oligomers or low molecular weight polymers of branched and/or linear alpha olefins. In some embodiments, the PAO comprises C₆ to C₂₀₀₀, or C₈ to C₁₅₀₀, or C₁₀ to C₁₀₀₀, or C₁₅ to C₈₀₀, or C₂₀ to C₄₀₀, or C₃₀ to C₂₅₀ oligomers of α-olefins. These oligomers may be dimers, trimers, tetramers, pentamers, etc. In some embodiments, the PAO comprises C₂ to C₂₄, preferably C₅ to C₁₈, more preferably C₆ to C₁₄, even more preferably C₈ to C₁₂, most preferably C₁₀ branched or linear α-olefins. In some embodiments, the PAO comprises C₃ to C₂₄, preferably C₅ to C₈, more preferably C₆ to C₁₄, most preferably C₈ to C₁₂ linear α-olefins (LAOs). Suitable olefins include 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, and blends thereof. Oligomers of LAOs with only even carbon numbers between 6 and 18 (inclusive) are particularly preferred. Preferably C₂, C₃, and C₄ α-olefins (i.e., ethylene, propylene, and 1-butene and/or isobutylene) are present in the PAO oligomers at an average concentration of 30 wt % or less, or 20 wt % or less, or 10 wt % or less, or 5 wt % or less; more preferably C₂, C₃, and C₄ α-olefins are not present in the PAO oligomers.

In some embodiments, the PAO comprises oligomers of a single LAO or a single α-olefin species. For example, the PAO may comprise oligomers of a single α-olefin species having a carbon number of 5 to 24 (preferably 6 to 18, preferably 8 to 12, most preferably 10). For example, the PAO may be formed by the oligomerization of 1-decene, and the PAO is a mixture of oligomers (including, for example, dimers, trimers, tetramers, pentamers, and higher) of 1-decene.

In some embodiments, the PAO may comprise a blend of oligomers of two or more LAOs or oligomers of mixed α-olefins (i.e., involving two or more α-olefin species). For example, the PAO may comprise a blend of oligomers of two more C₃ to C₂₄ α-olefins, or C₅ to C₂₄ α-olefins, or C₆ to C₁₈ α-olefins, or C₈ to C₁₂ α-olefins (inclusive of C₈ and C₁₂). Thus, in some embodiments, the mixture of α-olefins may be used to make ‘bipolymer’ or ‘terpolymer’ or higher-order copolymer combinations, provided that C₃ and C₄ LAOs are present at 10 wt % or less. For example, in some embodiments the PAO may comprise oligomers of mixed α-olefins where the weighted average carbon number for the α-olefin mixture is 6 to 14 (preferably 8 to 12, preferably 9 to 11). In some preferred embodiments, the PAO comprises an oligomerization of a mixture of 1-octene, 1-decene, and 1-dodecene, and the PAO is a mixture of oligomers (for example, dimers, trimers, tetramers, pentamers, and higher) of 1-octene/1-decene/1-dodecene ‘terpolymer’.

In another embodiment, the PAO comprises oligomers of one or more α-olefin with repeat unit formulas of:

—[CHR—CH₂]—

where R is a C₃ to C₁₈ saturated hydrocarbon branch. Preferably R is constant for all oligomers. In another embodiment, there is a range of R substituents covering carbon numbers from 3 to 18. Preferably R is linear, i.e.,

R is (CH₂)_{z}CH₃,

where z is 2 to 17 (preferably 3 to 11, preferably 4 to 9). Optionally, R may contain one methyl or ethyl branch, i.e.,

R is (CH₂)ₘ[CH(CH₃)](CH₂)ₙCH₃ or (CH₂)ₓ[CH(CH₂CH₃)](CH₂)_{y}CH₃,

where (m+n) is 1 to 15 (preferably 1 to 9, preferably 3 to 7) and (x+y) is 1 to 14 (preferably 1 to 8, preferably 2 to 6). Preferably m >n. Preferably m is 0 to 15 (preferably 2 to 15, preferably 3 to 12, preferably 4 to 9) and n is 0 to 10 (preferably 1 to 8, preferably 1 to 6, preferably 1 to 4). Preferably x >y. Preferably x is 0 to 14 (preferably 1 to 14, preferably 2 to 11, preferably 3 to 8) and y is 0 to 10 (preferably 1 to 8, preferably 1 to 6, preferably 1 to 4). Preferably the repeat units are arranged in a head-to-tail fashion with minimal heat-to-head connections.

The PAO may be atactic, isotactic, or syndiotactic. In one embodiment, the PAO has essentially the same population of meso [m] and racemic [r] dyads (preferably neither [m] nor [r] greater than 60%, preferably neither greater than 55%) as measured by ¹³C-NMR, making it atactic. In another embodiment, the PAO has more than 60% (preferably more than 70%, preferably more than 80%, preferably more than 90%) meso dyads [m]. In another embodiment, the PAO has more than 60% (preferably more than 70%, preferably more than 80%, preferably more than 90%) racemic dyads [r]. In one embodiment, [m]/[r] determined by ¹³C-NMR is between 0.9 and 1.1 in one embodiment, [m]/[r] is greater than 1 in another embodiment, and [m]/[r] is less than 1 in yet another embodiment.

The PAO may have a number average molecular weight (Mₙ) in the range of 1,000 to 50,000 g/mol, or 3,000 to 40,000 g/mol, or 5,000 to 30,000 g/mol, or 7,000 to 20,000 g/mol.

The PAOs may have a weight average molecular weight (M,) of less than 50,000 g/mol, or less than 40,000 g/mol, or less than 30,000 g/mol, or less than 20,000 g/mol, or less than 15,000 g/mol. In some embodiments, the PAO may have an Mₙ of 500 g/mol or more, 1000 g/mol or more, or 2000 g/mol or more, or 3000 g/mol or more, or 4000 g/mol or more, or 5000 g/mol or more, or 7000 g/mol or more. In some embodiments, the PAO may have a Mw in the range of from 500 to 50,000 g/mol, or from 1000 to 40,000 g/mol, or from 2000 to 30,000 g/mol, or from 5000 to 20,000 g/mol, or from 7000 to 15,000 g/mol.

Useful PAOs may have a kinematic viscosity (“KV”) at 100° C., as measured by ASTM D445 at 100° C., of greater than 50 cSt (1 cSt=1 mm²/s), or greater than 100 cSt, or greater than 150 cSt, or greater than 200 cSt, or greater than 300 cSt, or greater than 400 cSt, or greater than 500 cSt, or greater than 600 cSt, or greater than 700 cSt, or greater than 800 cSt, or greater than 900 cSt, or greater than 950 cSt. The PAO may have a KV at 100° C. of less than 10,000 cSt, or less than 7,500 cSt, or less than 5,000 cSt, or less than 3,000 cSt, or less than 2,000 cSt, or less than 1,500 cSt. In some embodiments, the PAO has a KV at 100° C. of 50 to 10,000 cSt, or 100 to 7,500 cSt, or 100 to 3,000 cSt, or 200 to 5,000 cSt, or 500 to 3,000 cSt, or 700 to 2,000 cSt, or 900 to 1,500 cSt.

Useful PAOs may have a kinematic viscosity (“KV”) as measured by ASTM D445 at 40° C. of 1000 to about 20,000 cSt, about 1100 to 15,000 cSt, or 1200 to 12,000 cSt, or 2000 to 11,000 cSt, or 5000 to 11,000 cSt, or 7500 to 10,500 cSt.

The PAOs may also have a viscosity index (“VI”), as determined by ASTM D2270, of 50 to 500, or 70 to 450, or 100 to 400, or 200 to 350.

The PAO may have a pour point, as determined by ASTM D5950/D97, of −100° C. to 0° C., −75° C. to −5° C., −50° C. to −7° C., −40° C. to −10° C., or −30° C. to −15° C. In some embodiments, the PAO or blend of PAOs has a pour point of −5 to −30° C., preferably −10 to −20° C.

The PAO may have a flash point, as determined by ASTM D92, of 150° C. or more, 200° C. or more, 210° C. or more, 220° C. or more, 230° C. or more.

The PAO may have a specific gravity, as determined by ASTM D4052 at 15.6° C. and 1 atm, of 0.79 to 0.90, 0.80 to 0.89, 0.81 to 0.88, 0.82 to 0.87, or 0.83 to 0.86.

Particularly preferred PAOs are those having (a) a flash point of 200° C. or more, 210° C. or more, 220° C. or more, or 230° C. or more; and (b) a pour point less than −5° C., less than −10° C., or less than −15° C.; and (c) a KV at 100° C. of 50 cSt or more, 100 cSt or more, 500 cSt or more, or 750 cSt or more.

Further preferred PAOs have a KV at 100° C. of 750 to 2000 cSt, or 900 to 1500 cSt; a pour point of −5 to —30° C., or −10 to −20° C.; and a specific gravity of 0.82 to 0.88, or 0.83 to 0.87.

The PAO may be comprised of one or more distinct PAO components. In one embodiment, the PAO is a blend of one or more oligomers with different compositions (e.g., different α-olefin(s) were used to make the oligomers) and/or different physical properties (e.g., KV, pour point, VI, and/or T_{g}).

Useful PAOs include certain grades of SpectraSyn™ and SpectraSyn Ultra™ available from ExxonMobil Chemical Company (Houston, Tex., USA). Other useful PAOs include certain grades of Synfluid™ available from ChevronPhillips Chemical Company (Pasadena, Tex., USA), Durasyn™ available from Innovene (Chicago, Ill., USA), Nexbase™ available from Neste Oil (Keilaniemi, Finland), and Synton™ available from Chemtura Corporation (Middlebury, Conn., USA).

### Blend Compositions

Compositions according to the present invention comprise at least one PBE and at least one PAO. In some embodiments, the compositions may comprise one propylene-based elastomer and one PAO, while in other embodiments, the composition may comprise a blend of propylene-based elastomers blended with one PAO, or one propylene-based elastomer blended with a blend of PAOs, or blends of propylene-based elastomers blended with a blend of PAOs.

The composition may comprise, at least about 0.5 wt % PAO, or at least about 1 wt % PAO, or at least about 2 wt % PAO, or at least about 3 wt % PAO, or at least about 4 wt % PAO, or at least about 5 wt % PAO, or at least about 6 wt % PAO, or at least about 7 wt % PAO, or at least about 8 wt % PAO, or at least about 9 wt % PAO, or at least about 10 wt % PAO, based on the weight of the blend composition. The composition may comprise up to about 60 wt % PAO, up to about 55 wt % PAO, up to about 50 wt % PAO, up to about 45 wt % PAO, up to about 40 wt % PAO, up to about 35 wt % PAO, up to about 30 wt % PAO, up to about 25 wt % PAO, or up to about 20 wt % PAO, based on the weight of the blend composition.

In some embodiments the composition may comprise from about 0.5 to 60 wt % PAO, from about 1 to 50 wt % PAO, from about 1 to 40 wt % PAO, from about 1 to 20 wt % PAO, from about 2 to 45 wt % PAO, or from about 5 to 40 wt % PAO. In some embodiments, the composition is a lean blend and may comprise from about 0.5 to 20 wt % PAO, from about 1 to 15 wt % PAO, or from about 2 to 10 wt % PAO. In other embodiments, the composition is a concentrated blend and may comprise from about 10 to about 60 wt % PAO, from about 15 to 50 wt % PAO, from about 20 to 45 wt % PAO, or from about 30 to 45 wt % PAO.

The composition may comprise at least 40 wt % PBE, at least 45 wt % PBE, at least 50 wt % PBE, at least 55 wt % PBE, at least 60 wt % PBE, at least 65 wt % PBE, at least 70 wt % PBE, at least 75 wt % PBE, or at least 80 wt % PBE, based on the weight of the blend composition. The composition may comprise up to about 99.5 wt % PBE, up to about 99 wt % PBE, up to about 98 wt % PBE, up to about 97 wt % PBE, up to about 96 wt % PBE, up to about 95 wt % PBE, up to about 94 wt % PBE, up to about 93 wt % PBE, up to about 92 wt % PBE, up to about 91 wt % PBE, or up to about 90 wt % PBE, based on the weight of the blend composition.

In some embodiments, the composition may comprise from 40 to 99.5 wt % PBE, from 50 to 99 wt % PBE, from 60 to 99 wt % PBE, from 80 to 99 wt % PBE, from 75 to 98 wt % PBE, or from 60 to 95 wt % PBE. In some embodiments, the composition is a lean blend and may comprise from about 80 to 99.5 wt % PBE, from about 85 to 99 wt % PBE, or from about 90 to 98 wt % PBE. In other embodiments, the composition is a concentrated blend and may comprise from about 40 to 90 wt % PBE, from 50 to 85 wt % PBE, from 55 to 80 wt % PBE, or from 55 to 70 wt % PBE.

The composition may have a MFR, as measured according to ASTM D-1238 (2.16 kg weight @ 230° C.), greater than about 0.5 g/10 min, greater than about 1.0 g/10 min, greater than about 1.5 g/10 min, greater than about 2.0 g/10 min, greater than about 2.5 g/10 min, greater than about 3 g/10 min, greater than about 3.5 g/10 min, or greater than about 4 g/10 min. The composition may have an MFR less than about 100 g/10 min, less than about 50 g/10 min, less than about 25 g/10 min, less than about 15 g/10 min, less than about 10 g/10 min, or less than about 7 g/10 min. In some embodiments, the blend composition may have an MFR from about 0.5 to about 15 g/10 min, from about 1.0 to about 10 g/10 min, or from about 3 to about 7 g/10 min.

A variety of additives may be incorporated into the compositions described herein, depending upon the intended purpose. For example, when the blends are used to form films, fibers, and nonwoven fabrics, such additives may include but are not limited to stabilizers, antioxidants, fillers, colorants, nucleating agents, dispersing agents, mold release agents, slip agents, fire retardants, plasticizers, pigments, vulcanizing or curative agents, vulcanizing or curative accelerators, cure retarders, processing aids, tackifying resins, and the like. Other additives may include fillers and/or reinforcing materials, such as carbon black, clay, talc, calcium carbonate, mica, silica, silicate, combinations thereof, and the like. Primary and secondary antioxidants include, for example, hindered phenols, hindered amines, and phosphates. Nucleating agents include, for example, sodium benzoate and talc. Also, to improve crystallization rates, other nucleating agents may also be employed. Other additives such as dispersing agents, for example, Acrowax C, can also be included. Slip agents include, for example, oleamide and erucamide. Catalyst deactivators are also commonly used, for example, calcium stearate, hydrotalcite, and calcium oxide, and/or other acid neutralizers known in the art.

Further, in some exemplary embodiments, additives may be incorporated into the blend compositions directly or as part of a masterbatch, i.e., an additive package containing several additives to be added at one time in predetermined proportions. The masterbatch may be added in any suitable amount to accomplish the desired result. For example, a masterbatch comprising an additive may be used in an amount ranging from about 0.1 to about 10 wt %, or from about 0.25 to about 7.5 wt %, or from about 0.5 to about 5 wt %, or from about 1 to about 5 wt %, or from about 2 to about 4 wt %, based on the total weight of the polymer blend and the masterbatch.

The compositions described herein may have a first cycle hysteresis top load at 50% strain of less than 25N, or less than 23N, or less than 20N, or less than 18N, or less than 16N, or less than 15N.

The compositions described herein may have a first cycle hysteresis top load at 100% strain of less than 30N, or less than 28N, or less than 26N, or less than 24N, or less than 22N, or less than 20N, or less than 18N.

The compositions described herein may have a first cycle hysteresis retractive force at 50% strain of less than 15N, or less than 12N, or less than 10N, or less than 8N.

The compositions described herein may have a second cycle hysteresis top load at 50% strain of less than 20N, less than 18N, less than 16N, less than 14N, or less than 12N.

The compositions described herein may have a second cycle hysteresis top load at 100% strain of less than 30N, less than 28N, less than 26N, less than 24N, less than 22N, less than 20N, less than 18N, or less than 16N.

The compositions described herein may have a second cycle hysteresis retractive force at 50% strain of less than 12N, or less than 10N, or less than 9N, or less than 8N.

The blend compositions described herein can have a first cycle hysteresis top load at 50% strain that is at least 15% lower, or 20% lower, or 30% lower, or 40% lower, or 45% lower, than a similar composition containing the same PBE but that contains no PAO.

To determine the top load and retractive force of the blend, the following test method may be used. A compression molded test specimen is tested at room temperature where the specimen is stretched uniaxially using a grip separation of 25.4 mm and at a cross-head speed of 508 mm/min to a maximum strain (either 50% or 100%) where the stress is immediately removed and the specimen is allowed to retract or unload at the same cross-head speed. The test specimens are extended to 100% and then returned to zero load without any hold (“first cycle hysteresis”). The hysteresis properties were also measured in a second cycle after the completion of the first cycle stretch to 100% extension. The top load is defined as the maximum loading stress measured at the cycle strain. The 50% top load is defined as the loading stress measured at 50% of the cycle strain. The retractive force is defined as the unloading stress measured during the unloading portion of the cycle at 50% of the cycle strain.

Morphological analysis of the blend compositions may be performed using Atomic Force Microscopy (AFM) in bi-modal tapping mode. In embodiments, where the PBE is a reactor blended polymer the morphological analysis may illustrate the phases existing in the blend. For example in an AFM image, the blend may comprise dark phases that corresponds to the high modulus second reactor (R2) random copolymer component of the PBE, while the lighter phases are the less crystalline and lower modulus propylene-ethylene copolymer (R1) component. In some embodiments, the PAO may blend with the PBE such as to form a droplet morphology in the blend where the PAO and the amorphous propylene-ethylene (R1 component) form sub-inclusions inside the random copolymer phase (R2 component). Thus, if the random copolymer component is considered to be rigid inclusions which reinforce the amorphous propylene-ethylene matrix, a composite droplet containing a mixture of the amorphous propylene-ethylene and PAO sub-inclusion within the random copolymer component may lead to a lower modulus compared to the random copolymer without sub-inclusions. Thus, without being bound by theory, it is believed that the blend compositions comprising the high viscosity PAO form a droplet morphology where the PAO and the amorphous propylene-ethylene component of the PBE form sub-inclusions within the random copolymer phase of the PBE which then exhibit lower top loads as described above.

### Methods for Preparing the Blend Composition

The blend compositions described herein may be formed by combining the propylene-based elastomer and the polyalphaolefin, and other optional fillers and additives using any suitable means known in the polymer processing art. Those skilled in the art will be able to determine the appropriate methods to enable intimate mixing while also achieving process economy. For example, the components may be blended in a tumbler, continuous mixer, static mixer, batch mixer, extruder, or a combination thereof that is sufficient to achieve an adequate dispersion of the components. For example, the components may be melt-blended in a batch mixer, such as a Banbury™ or Brabender™ mixer.

In some embodiments, the blend composition may be prepared by combining the PBE and PAO components during a process used to fabricate articles, without first making a pelletized version of the composition. For example, the PAO may be added to other components in a production extruder, such as the extruder on an injection molding machine or on a continuous extrusion line, and thereafter directly processed into a film, sheet, fiber, profile, etc. For example, the PBE and PAO components may be combined in a melt-blending (compounding) step and subsequent pelletizing step, using either an underwater pelletizer or a strand-cut approach (i.e., a water batch and dry pelletizer). This approach may involve an on-line “finishing” extruder associated with a polymerization unit, or it may involve an off-line “compounding” extruder dedicated to melt blending.

In other embodiments, the blend composition is prepared by a method that comprises combining the PBE and PAO components and then pelletizing the blend compositions. Without being bound by theory, it is believed that, by pelletizing the blend composition before forming the fabricated article that a more uniform dispersion of the PAO within the PBE is achieved. This in turn allows for a more uniform dispersion of the PAO within the fabricated article, allowing for improvements in softness of stretch of the fabricated article. Therefore, in some embodiments, the fabricated article may be prepared by a method comprising the steps of: (a) combining (i) a propylene-based elastomer comprising at least about 60 wt % propylene-derived units and about 5 to about 25 wt % ethylene-derived units, based on total weight of the propylene-based elastomer and (ii) a polyalphaolefin to form a blend; (b) pelletizing the blend to form a pellet composition; and (c) using the pellet composition to form a fabricated article.

In some embodiments, the method of blending may be to melt blend the components in an extruder, such as a single-screw extruder or a twin-screw extruder. Extrusion technology for polymer blends is well known in the art, and is described in more detail in, for example, PLASTICS EXTRUSION TECHNOLOGY, F. Hensen, Ed. (Hanser, 1988), pp. 26-37, and in POLYPROPYLENE HANDBOOK, E. P. Moore, Jr. Ed. (Hanser, 1996), pp. 304-348. For example, the PAO may be directly injected into the polymer melt using a liquid injection device at some point along the barrel, as in the case of a twin-screw extruder, or through an opening in a hollow screw shaft, as in the case of a single-screw extruder. PAO is preferably added downstream from the polymer melt zone, but alternatively the PAO can be added at a point where the polymer(s) have not fully melted yet. For example, in a twin-screw extruder, PAO can be injected after the first barrel section (preferably after the first third of the barrel, more preferably in the last third of the barrel). A PAO addition point may be on top of conveying elements of screw, or on top of liquid mixing elements of screw, or prior to kneading elements of screw, or prior to liquid mixing elements of the screw. The extruder may have more than one (preferably two or three) PAO addition points along the barrel or screw shaft. Optionally, the PAO can be added via the extruder feed throat.

The components may also be blended by a combination of methods, such as dry blending followed by melt blending in an extruder, or batch mixing of some components followed by melt blending with other components in an extruder. One or more components may also be blended using a double-cone blender, ribbon blender, or other suitable blender, or in a Farrel Continuous Mixer (FCM™).

Blending may also involve a “masterbatch” approach, where the target PAO concentration is achieved by combining neat propylene-based elastomer(s) and optionally thermoplastic polyolefin(s) and fillers and/or additives with an appropriate amount of pre-blended masterbatch (i.e., a blend of the propylene-based elastomer, PAO, and optionally the thermoplastic polyolefin and the filler and additives that have been previously prepared at a higher concentration of PAO than desired in the final blend). This is a common practice in polymer processing, typically used for addition of color, additives, and fillers to final compositions. Dispersion (or “letdown”) of the masterbatch may take place as part of a processing step used to fabricate articles, such as in the extruder on an injection molding machine or on a continuous extrusion line, or during a separate compounding step.

Films Prepared from the Blend Composition

Films may be prepared from the blend compositions described herein. The film may be formed by any number of well-known extrusion or co-extrusion techniques. For example, any of the blown or chill roll techniques are suitable. For example, the blend composition may be extruded in a molten state through a flat die and then cooled. Alternatively, the blend composition may be extruded in a molten state through an annular die and then blown and cooled to form a tubular film. The tubular film may be axially slit and unfolded to form a flat film. The films may be unoriented, uniaxially oriented or biaxially oriented.

Multiple-layer films may also be formed using methods well known in the art. For example, layer components may be coextruded through a coextrusion feedblock and die assembly to yield a film with two or more layers adhered together, but differing in composition. Multiple-layer films may also be formed by extrusion coating whereby a substrate material is contacted with the hot molten polymer as the polymer exits the die. For instance, an already formed film may be extrusion coated with a layer of the blend compositions described herein as the latter is extruded through the die. Multiple-layer films may also be formed by combining two or more single layer films prepared as described above. The total thickness of multilayer films may vary based upon the application desired. Those of skill in the art will appreciate that the thickness of individual layers for multilayer films may be adjusted based on desired end use performance, polymer compositions employed, equipment capability, and other like factors.

The total thickness of the film may vary based upon the application desired. In some embodiments the total unstretched film thickness is about 1.0-100.0 μm. Typically, elastic films have a thickness of about 5-50 μm in most applications.

Thus, provided herein are films comprising a blend composition, where the blend composition comprises a PAO and a propylene-based elastomer as described herein. The film may have improved soft-stretch as compared to films comprising similar propylene-based elastomers but that do not contain the PAO and as compared to films comprising similar propylene-based elastomers and lower viscosity PAOs.

### Fibers and Nonwoven Compositions

The compositions described herein may be useful in meltspun (e.g., meltblown or spunbond) fibers and nonwoven compositions (e.g., fabrics). As used herein, “meltspun nonwoven composition” refers to a composition having at least one meltspun layer, and does not require that the entire composition be meltspun or nonwoven. As used herein, “nonwoven” refers to a textile material that has been produced by methods other than weaving. In nonwoven fabrics, the fibers are processed directly into a planar sheet-like fabric structure and then are either bonded chemically, thermally, or interlocked mechanically (or both) to achieve a cohesive fabric.

Nonwoven compositions comprising the blend of the PAO and PBE may be described as extensible. “Extensible,” as used herein, means any fiber or nonwoven composition that yields or deforms (i.e., stretches) upon application of a force. While many extensible materials are also elastic, the term extensible also encompasses those materials that remain extended or deformed upon removal of the force. When an extensible facing layer is used in combination with an elastic core layer, the extensible layer may permanently deform when the elastic layer to which it is attached stretches and retracts, creating a wrinkled or textured outer surface which gives an additional soft feel that is particularly suited for articles in which the facing layer is in contact with a wearer's skin.

The fibers and nonwoven compositions of the present invention can be formed by any method known in the art. For example, the nonwoven compositions may be produced by a spunmelt process. In certain embodiments herein, the layer or layers of the nonwoven compositions of the invention are produced by a spunbond process. When the compositions further comprise one or more elastic layers, the elastic layers may be produced by a meltblown process, by a spunbond or spunlace process, or by any other suitable nonwoven process.

Fibers produced from the blend compositions may have a thickness from about 0.5 to about 10 denier, or from about 0.75 to about 8 denier, or from about 1 to about 6 denier, or from about 1 to about 3 denier. Although commonly referred to in the art and used herein for convenience as an indicator of thickness, denier is more accurately described as the linear mass density of a fiber. A denier is the mass (in grams) of a fiber per 9,000 meters. In practice, measuring 9,000 meters may be both time-consuming and wasteful. Usually, a sample of lesser length (i.e., 900 meters, 90 meters, or any other suitable length) is weighed and the result multiplied by the appropriate factor to obtain the denier of the fiber.

The fiber denier (g/9000 m) of a polypropylene-based fiber can be converted to diameter in microns using the following formula:

$$D = \sqrt[2]{\frac{denier}{( 0.006432 )}}$$

Thus, a 1.0 denier polypropylene fiber would have a diameter of about 12.5 micron and a 2.0 denier polypropylene fiber would have a diameter of 17.6 micron.

The fibers may be monocomponent fibers or bicomponent fibers. Preferably, the fibers are monocomponent fibers, meaning that the fibers have a consistent composition throughout their cross-section.

The layer that comprises the blend may have a basis weight of less than 50 g/m² (“gsm”), or less than 40 gsm, or less than 30 gsm, or less than 25 gsm, or less than 20 gsm. The layer that comprises the blend may have a basis weight of from about 1 to about 75 g/m² (“gsm”), or from about 2 to about 50 gsm, or from about 5 to about 35 gsm, or from about 7 to about 25 gsm, or from about 10 to about 25 gsm.

In addition to good extensibility and elongation, fibers comprising the blends to described herein may also be used to produce fabrics that have improved aesthetics. For example, the fabrics may have an improved feel and softness. Without being bound by theory, it is believed that fabrics produced using the blends described herein have lower bending modulus, due to lower crystallinity, which improves the softness or feel of the fabric. Fabrics made from fibers comprising the blends described herein may have improved softness, as measured by a Handle-O-Meter.

As used herein, “meltblown fibers” and “meltblown compositions” (or “meltblown fabrics”) refer to fibers formed by extruding a molten thermoplastic material at a certain processing temperature through a plurality of fine, usually circular, die capillaries as molten threads or filaments into high velocity, usually hot, gas streams which attenuate the filaments of molten thermoplastic material to reduce their diameter, which may be to microfiber diameter. Thereafter, the meltblown fibers are carried by the high velocity gas stream and are deposited on a collecting surface to form a web or nonwoven fabric of randomly dispersed meltblown fibers. Such a process is generally described in, for example, U.S. Pat. Nos. 3,849,241 and 6,268,203. The term meltblowing as used herein is meant to encompass the meltspray process.

In a typical spunbond process, polymer is supplied to a heated extruder to melt and homogenize the polymers. The extruder supplies melted polymer to a spinneret where the polymer is fiberized as passed through fine openings arranged in one or more rows in the spinneret, forming a curtain of filaments. The filaments are usually quenched with air at a low temperature, drawn, usually pneumatically, and deposited on a moving mat, belt or “forming wire” to form the nonwoven composition. See, for example, in U.S. Pat. Nos. 4,340,563; 3,692,618; 3,802,817; 3,338,992; 3,341,394; 3,502,763; and 3,542,615. The term spunbond as used herein is meant to include spunlace processes, in which the filaments are entangled to form a web using high-speed jets of water (known as “hydroentanglement”).

### Elastic Laminates

The blend compositions described herein may be particularly useful in forming a film layer that is part of an elastic laminate. The elastic laminate may comprise at least one film layer containing the blend composition and at least one nonwoven facing layer. For example, in some embodiments the elastic laminate comprises an inner elastic film layer and two outer nonwoven facing layers. The outer nonwoven facing layers may be made from any polymer that is suitable for forming nonwoven facing layers, and for example may be made from polypropylene, propylene-ethylene copolymers, propylene-based elastomers, polyethylene, polyethylene-terephthalate blends (PET), and blends thereof.

A typical laminate or composite has three or more layers, with the elastic film layer(s) (“F”) sandwiched between two or more outer fabric layers that may be spunbonded layers (“S”), meltblown layers (“M”), or spunlace layers (“L”). Examples of laminate combinations include, but are not limited to SFS, MFS, LFL, SFM, SFL, MFL, SSMFMSS, SMFMS, and SMMSS composites. Composites can also be made of the meltblown or spunbond nonwovens of the invention with other materials, either synthetic or natural, to produce useful articles.

The nonwoven laminate composition may comprise one or more elastic film layers comprising a PBE and further comprise one or more nonwoven facing layers as described herein positioned on one or both sides of the elastic layer(s). In some embodiments, the film is made in a first process and then the roll of film is laminated to nonwoven facing layers, for example, by pressing the layers through a nip and using heat and pressure to bond the nonwoven layers to the film layers, or by ultrasonic bonding, or by using a hot melt adhesive. In some embodiments, the nonwoven laminate is made in an extrusion lamination process where the film layer is extruded onto a pre-existing nonwoven fabric layer. In some embodiments, the nonwoven laminate is made by forming the nonwoven layer directly onto the film layer.

The nonwoven products described above may be used in many articles such as hygiene products including, but not limited to, diapers, feminine care products, and adult incontinent products. The nonwoven products may also be used in medical products such as sterile wrap, isolation gowns, operating room gowns, surgical gowns, surgical drapes, first aid dressings, and other disposable items. In particular the nonwoven products may be useful as facing layers for medical gowns, and allow for extensibility in the elbow area of the gown. The nonwoven products may also be useful in disposable protective clothing, and may add toughness to elbow and knee regions of such clothing. The nonwoven products may also be useful as protective wrapping, packaging or wound care. The nonwoven products may also be useful in geotextile applications, as the fabric may have improved puncture resistance in that the fabric will deform instead of puncture.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

The propylene-based elastomer (PBE) used in the Examples was a metallocene-catalyzed reactor blended PBE. The PBE was a dual reactor polymer having a first reactor component (R1) and a second reactor component (R2) made in parallel solution polymerization reactors, with the reaction effluent from each reactor being blended together to give the final reactor blended PBE. The minor fraction (5-15 wt %) of the PBE had a higher crystallinity and lower ethylene content relative to the major fraction, with the major fraction having a higher ethylene content and imparting elastic properties to the PBE. The PBE used in the Examples contained 500-1500 ppm Irganox™ 1076 antioxidant and had the properties described in Table 1.

TABLE 1
PBE Properties

| | | MFR | |
|---|---|---|---|
| | | (I₂ at 230° C.) | |
| PBE | Overall C2, wt % | g/10 min | Density |
| PBE-1 | 16.6 | 3.0 | 0.861 |

The PAOs used in the Examples had the properties described in Table 2. The specific gravity (SG) can be measured at 15.6° C. (1 atm) using ASTM D4052. The kinematic viscosity (KV) can be measured at both 40° C. and 100° C. using ASTM D445. The viscosity index (VI) can be measured using ASTM D2270. The pour point can be measured using ASTM D5959/D97. The flash point (COC) can be measured using ASTM D92.

TABLE 2
PAO Properties

| | SG @ | KV @ | | KV @ | | | Pour | Flash Point | |
|---|---|---|---|---|---|---|---|---|---|
| PAO | 15.6° C. | 100° C. | | 40° C. | | VI | Point, ° C. | (COC) ° C. | Mw |
| PAO-2 | 0.798 | 1.7 | cSt | 5 | cSt | — | −66° C. | 157° C. | — |
| PAO-10 | 0.835 | 10.0 | cSt | 66 | cSt | 137 | −48° C. | 266° C. | <1000 |
| | | | | | | | | | g/mole |
| PAO-100 | 0.853 | 100 | cSt | 1240 | cSt | 170 | −30° C. | 283° C. | — |
| PAO-1000 | 0.855 | 1000 | cSt | 10000 | cSt | 307 | −18° C. | >265° C. | — |

PAOs with different kinematic viscosities (KV at 100° C.) ranging from 2 cSt to 1000 cSt were blended with PBE resin to form blend compositions. The formulations for the blend compositions are listed in Table 3. The blend compositions were prepared in a Brabender mixer using a batch size of 250 grams. The PBE resin was charged into the cavity of the Brabender mixer that was pre-heated to about 160° C. The rotor rpm was increased to 50 rpm to melt and homogenize the polymer in the mixer. The PAO, which was pre-weighed, was added into the Brabender mixer cavity using a syringe. Mixing was continued for 3 minutes at 50 rpm after the addition of the PAO, at which time the mixer was stopped and the blend removed. The blend was cooled to ambient conditions and separated by hand into smaller fragments for ease of handling.

TABLE 3
Blend Formulations

| | Control | Blend 1 | Blend 2 | Blend 3 | Blend 4 |
|---|---|---|---|---|---|
| PBE-1 | 100 | 95 | 95 | 95 | 95 |
| PAO-2 | 0 | 5 | 0 | 0 | 0 |
| PAO-10 | 0 | 0 | 5 | 0 | 0 |
| PAO-100 | 0 | 0 | 0 | 5 | 0 |
| PAO-1000 | 0 | 0 | 0 | 0 | 5 |
| Total (wt %) | 100 | 100 | 100 | 100 | 100 |

Samples of the blend compositions were compression molded and tested for physical properties with the results listed in Table 4. In the Examples, the hysteresis response of each test specimen was measured in tension using a grip separation of 25.4 mm and a cross-head speed of 508 mm/minute. The test specimens were extended to 100% and then returned to zero load without any hold (“first cycle hysteresis”). The hysteresis properties were also measured in a second cycle after the completion of the first cycle stretch to 100% extension.

The cycle strain is defined as the maximum strain attained during the hysteresis cycle testing. For example, for a 100% cycle, the cycle strain is 100%. The top load is defined as the maximum loading stress measured at the cycle strain. The 50% top load is defined as the loading stress measured at 50% of the cycle strain. The retractive force is defined as the unloading stress measured during the unloading portion of the cycle at 50% of the cycle strain. The 1^{st}-cycle permanent set is defined as the strain upon which the first cycle unload is reduced to zero load. Mechanical hysteresis is defined as the area inside of the hysteresis curve normalized to the area of the load curve and represents the amount of applied energy lost or the amount of unrecoverable energy per initial gauge length. In general, the lower the permanent set and lower the mechanical hysteresis value, the more elastic is the material.

TABLE 4
Properties of Blend Compositions with 5 wt % PAO

| | | Control | Blend 1 | Blend 2 | Blend 3 | Blend 4 |
|---|---|---|---|---|---|---|
| MFR (230° C., 2.16 kg) | g/10 min | 2.8 | 4.3 | 3.9 | 5.3 | 3.7 |
| First Cycle Hysteresis | | | | | | |
| (average of 3 samples) | | | | | | |
| Top Load at 50% Strain | N | 28.6 | 21.4 | 22.6 | 22.9 | 20.3 |
| Reduction Compared to Control | % | — | −25.1 | −20.9 | −20.0 | −29.0 |
| Top Load at 100% Strain | N | 32.1 | 24.3 | 25.6 | 26.1 | 22.5 |
| Reduction Compared to Control | % | — | −24.3 | −20.2 | −18.8 | −29.8 |
| Retractive Force @ 50% Strain | N | 15.1 | 11.0 | 12.3 | 12.7 | 10.3 |
| Load Loss | % | 47.0 | 48.7 | 45.7 | 44.5 | 49.6 |
| Permanent Set | % | 12.7 | 12.4 | 11.2 | 11.4 | 12.9 |
| Mechanical Hysteresis | % | 44.2 | 45.3 | 42.7 | 42.0 | 46.2 |
| Second Cycle Hysteresis | | | | | | |
| (average of 3 samples) | | | | | | |
| Top Load at 50% Strain | N | 21.1 | 15.2 | 16.4 | 16.9 | 14.6 |
| Reduction Compared to Control | % | — | −27.9 | −22.3 | −19.9 | −30.8 |
| Top Load at 100% Strain | N | 30.4 | 22.8 | 24.2 | 24.8 | 21.2 |
| Reduction Compared to Control | % | — | −25.0 | −20.4 | −18.4 | −30.3 |
| Retractive Force @ 50% Strain | N | 14.3 | 10.4 | 11.7 | 12.2 | 9.7 |
| Load Loss | % | 32.1 | 31.8 | 29.0 | 27.9 | 34.0 |
| Permanent Set | % | 7.8 | 7.1 | 6.2 | 6.5 | 7.9 |
| Mechanical Hysteresis | % | 28.4 | 28.0 | 25.8 | 25.2 | 29.9 |

Shown in Table 4 is the reduction in the top load measured at 50% strain and 100% strain respectively for the blend compositions with reference to the Control sample which did not contain PAO. Blend 4 containing the PAO-1000 exhibited the maximum reduction in top load. Blend 4 also exhibited the lowest top load in the second cycle hysteresis when compared to the Control and Blends 1-3.

Table 5 shows additional blend compositions containing 7 wt % PAO and properties of the blend compositions. The blend compositions in Table 5 were made as described above with reference to the 5 wt % PAO formulations and tested using the same test methods. As seen in Table 5, Blend 8 containing the PAO-1000 again showed the lowest top load in the second cycle hysteresis, when compared to the Control and Blends 5-7.

TABLE 5
Blend Compositions with 7 wt % PAO and Their Properties

| | | Control | Blend 5 | Blend 6 | Blend 7 | Blend 8 |
|---|---|---|---|---|---|---|
| Blend Formulation | | | | | | |
| PBE-1 | wt % | 100 | 93 | 93 | 93 | 93 |
| PAO-2 | wt % | 0 | 7 | 0 | 0 | 0 |
| PAO-10 | wt % | 0 | 0 | 7 | 0 | 0 |
| PAO-100 | wt % | 0 | 0 | 0 | 7 | 0 |
| PAO-1000 | wt % | 0 | 0 | 0 | 0 | 7 |
| Total | wt % | 100 | 100 | 100 | 100 | 100 |
| MFR (230° C., 2.16 kg) | g/10 min | 2.8 | 4.3 | 4.6 | 4.2 | 4.5 |
| First Cycle Hysteresis | | | | | | |
| (average of 3 samples) | | | | | | |
| Top Load at 50% Strain | N | 28.6 | 21.3 | 23.3 | 22.7 | 16.4 |
| Reduction Compared to Control | % | — | −25.5 | −18.5 | −20.8 | −42.7 |
| Top Load at 100% Strain | N | 32.1 | 24.4 | 26.5 | 26.2 | 18.2 |
| Reduction Compared to Control | % | — | −24.1 | −17.4 | −18.3 | −43.2 |
| Retractive Force @ 50% Strain | N | 15.1 | 11.5 | 12.5 | 12.8 | 8.5 |
| Load Loss | % | 47.0 | 46.0 | 46.4 | 43.4 | 48.4 |
| Permanent Set | % | 12.7 | 11.9 | 12.0 | 11.1 | 12.4 |
| Mechanical Hysteresis | % | 44.2 | 43.2 | 43.4 | 41.0 | 45.1 |
| Second Cycle Hysteresis | | | | | | |
| (average of 3 samples) | | | | | | |
| Top Load at 50% Strain | N | 21.1 | 15.5 | 16.9 | 16.7 | 11.8 |
| Top Load at 100% Strain | N | 30.4 | 23.0 | 25.1 | 25.0 | 17.1 |
| Retractive Force @ 50% Strain | N | 14.3 | 10.9 | 11.9 | 12.3 | 7.9 |
| Load Loss | % | 32.1 | 29.4 | 30.0 | 26.0 | 32.8 |
| Permanent Set | % | 7.8 | 7.0 | 7.2 | 5.9 | 8.0 |
| Mechanical Hysteresis | % | 28.4 | 26.3 | 26.6 | 23.6 | 29.0 |

Table 6 shows additional blend compositions containing 10 wt % PAO and properties of the blend compositions. The blend compositions were made as described above with reference to the 5 wt % PAO formulations and tested using the same test methods. As seen in Table 6, Blend 13 containing the PAO-1000 showed the lowest top load in the second cycle hysteresis, when compared to the Control and Blends 10-12.

TABLE 6
Blend Compositions with 10 wt % PAO and their Properties

| | | Control | Blend 10 | Blend 11 | Blend 12 | Blend 13 |
|---|---|---|---|---|---|---|
| Blend Formulation | | | | | | |
| PBE-1 | wt % | 100 | 90 | 90 | 90 | 90 |
| PAO-2 | wt % | 0 | 10 | 0 | 0 | 0 |
| PAO-10 | wt % | 0 | 0 | 10 | 0 | 0 |
| PAO-100 | wt % | 0 | 0 | 0 | 10 | 0 |
| PAO-1000 | wt % | 0 | 0 | 0 | 0 | 10 |
| Total | wt % | 100 | 100 | 100 | 100 | 100 |
| MFR (230° C., 2.16 kg) | g/10 min | 2.8 | 6.2 | 4.4 | 4.6 | 5.9 |
| First Cycle Hysteresis | | | | | | |
| (average of 3 samples) | | | | | | |
| Top Load at 50% Strain | N | 28.6 | 21.0 | 20.3 | 22.6 | 14.7 |
| Reduction Compared to Control | % | — | −26.5 | −29.1 | −27.2 | −48.7 |
| Top Load at 100% Strain | N | 32.1 | 24.4 | 23.5 | 26.3 | 16.2 |
| Reduction Compared to Control | % | — | −24.0 | −26.8 | −18.2 | −49.4 |
| Retractive Force @ 50% Strain | N | 15.1 | 11.7 | 11.3 | 12.5 | 7.5 |
| Load Loss | % | 47.0 | 44.3 | 44.2 | 44.7 | 48.9 |
| Permanent Set | % | 12.7 | 12.0 | 11.7 | 11.3 | 12.6 |
| Mechanical Hysteresis | % | 44.2 | 41.7 | 41.7 | 41.9 | 45.6 |
| Second Cycle Hysteresis | | | | | | |
| (average of 3 samples) | | | | | | |
| Top Load at 50% Strain | N | 21.1 | 15.4 | 15.0 | 16.4 | 10.5 |
| Top Load at 100% Strain | N | 30.4 | 23.1 | 22.4 | 25.0 | 15.2 |
| Retractive Force @ 50% Strain | N | 14.3 | 11.2 | 10.8 | 12.0 | 7.0 |
| Load Loss | % | 32.1 | 27.4 | 27.5 | 27.3 | 32.9 |
| Permanent Set | % | 7.8 | 6.5 | 6.6 | 6.1 | 8.1 |
| Mechanical Hysteresis | % | 28.4 | 24.6 | 24.8 | 24.5 | 29.2 |

FIG. 1 shows the first-cycle hysteresis curves for the formulations in Table 6. The important features of the hysteresis curves are the top load at 50% and 100% strain (extension), the retractive force measured as load at 50% extension on return and the permanent set. As seen in FIG. 1, the drop in top load when using Blend 13 is substantial (49% less than the Control) compared to the other formulations.

As seen in Table 6, the reduction in top load was higher when the viscosity of the PAO was greater than 100 cSt. As also seen in Table 6, the permanent set did not materially change with the increasing viscosity of the PAO and is similar to the Control sample which contained no PAO.

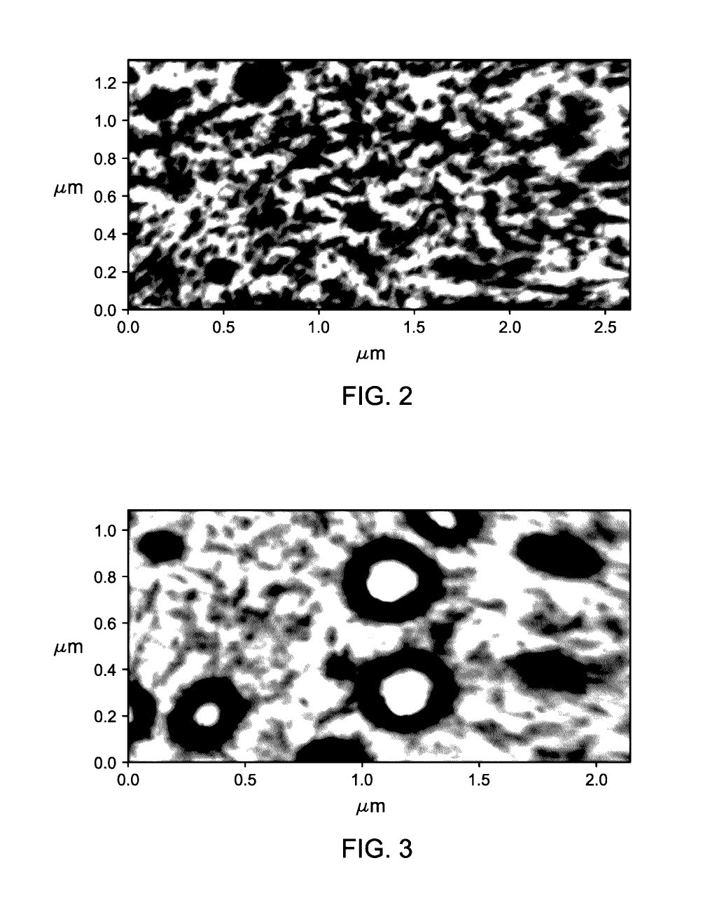

Morphological analysis of the blend compositions was determined using Atomic Force Microscopy (AFM) in bi-modal tapping mode. Phase contrasts in the AFM arise from differences in elastic modulus. The bi-modal mode of the AFM provides greater phase differentiation compared to AFM images using conventional tapping mode. FIGS. 2 and 3 are AFM images of blend compositions containing 10 wt % PAO-10 and PAO-1000, respectively. In the AFM images the dark phase corresponds to the high modulus second reactor (R2) random copolymer component of the PBE, while lighter phases are the less crystalline and lower modulus propylene-ethylene copolymer (R1) component. In FIG. 2, a cross hatch pattern of isotactic polypropylene lamellae corresponding to the propylene crystallinity of the R1 component of the PBE was observed. The yellow and dark orange phases (or white to light gray phases in the grayscale image) corresponded to elastomeric segments of progressively lower crystallinity. At least five to six different components differing in phase contrast can be seen in FIG. 2. The slightly darker regions appear to be preferentially located at the random copolymer interphase. The PAO is mainly localized in the amorphous phase of the blend in FIG. 2.

As seen in FIG. 3, the morphology of the blend containing the higher viscosity PAO differs from that in FIG. 2. In FIG. 3, there is a droplet morphology where the PAO and the amorphous propylene-ethylene (R1 component) formed sub-inclusions inside the random copolymer phase (R2 component). Thus, if the random copolymer component is considered to be rigid inclusions which reinforce the amorphous propylene-ethylene matrix, a composite droplet (as observed in FIG. 3) containing a mixture of the amorphous propylene-ethylene and PAO sub-inclusion within the random copolymer component leads to a lower modulus compared to the random copolymer without sub-inclusions (as seen in FIG. 2). Without being bound by theory, it is believed that the blend compositions having the rigid inclusions with lower modulus is less effective in reinforcement, thus, producing compositions with lower top loads as illustrated in Tables 4, 5, and 6 with the blends containing PAO-1000.

Having described the various aspects of the compositions herein, further specific embodiments of the invention include those set forth in the following paragraphs.

Embodiment A: A composition comprising from about 0.5 to about 60 wt % of a PAO and 40 to 99.5 wt % of a PBE, wherein the PBE comprises propylene-derived units and 5 to 30 wt % of α-olefin-derived units and where the PBE has a melting temperature of less than 120° C. and a heat of fusion of less than 75 J/g; and where the PAO has a kinematic viscosity (KV) at 100° C. of from 100 to 3000 cSt; and where the blend composition has at least one of the following properties:
(i) a first cycle hysteresis top load at 50% strain of less than 25N;
(ii) a first cycle hysteresis top load at 100% strain of less than 30N;
(iii) a first cycle hysteresis retractive force at 50% strain of less than 15N;
(iv) a second cycle hysteresis top load at 50% strain of less than 20N;
(v) a second cycle hysteresis top load at 100% strain of less than 30N;
(vi) a second cycle hysteresis retractive force at 50% strain of less than 12N; or
(vii) a first cycle hysteresis top load at 50% strain that is at least 15% lower than a similar composition containing the same PBE but that contains no PAO.

Embodiment B: The composition of Embodiment A, where the propylene-based polymer elastomer is a reactor blend of a first polymer component and a second polymer component, wherein the first polymer component comprises propylene and an α-olefin and has an α-olefin content R₁ of from greater than 5 to less than 30 wt % α-olefin, where the percentage by weight is based upon the total weight of the propylene-derived and α-olefin derived units of the first polymer component, and wherein the second polymer component comprises propylene and α-olefin and has an α-olefin content R₂ of from greater than 1 to less than 10 wt % α-olefin, where the percentage by weight is based upon the total weight of the propylene-derived and α-olefin derived units of the second polymer component.

Embodiment C: A composition comprising from about 0.5 to about 60 wt % of a PAO and 40 to 99.5 wt % of a PBE, where the propylene-based polymer elastomer is a reactor blend of a first polymer component and a second polymer component, wherein the first polymer component comprises propylene and an α-olefin and has an α-olefin content R₁ of from greater than 5 to less than 30 wt % α-olefin, where the percentage by weight is based upon the total weight of the propylene-derived and α-olefin derived units of the first polymer component, and wherein the second polymer component comprises propylene and α-olefin and has an α-olefin content R₂ of from greater than 1 to less than 10 wt % α-olefin, where the percentage by weight is based upon the total weight of the propylene-derived and α-olefin derived units of the second polymer component; where the PAO has a kinematic viscosity (KV) at 100° C. of from 100 to 3000 cSt; and where the blend composition has at least one of the following properties:
(i) a first cycle hysteresis top load at 50% strain of less than 25N;
(ii) a first cycle hysteresis top load at 100% strain of less than 30N;
(iii) a first cycle hysteresis retractive force at 50% strain of less than 15N;
(iv) a second cycle hysteresis top load at 50% strain of less than 20N;
(v) a second cycle hysteresis top load at 100% strain of less than 30N;
(vi) a second cycle hysteresis retractive force at 50% strain of less than 12N; or
(vii) a first cycle hysteresis top load at 50% strain that is at least 15% lower than a similar composition containing the same PBE but that contains no PAO.

Embodiment D: The composition of Embodiment C, wherein the total α-olefin content of the propylene-based elastomer is from 5 to 30 wt % α-olefin, where the percentage by weight is based upon the total weight of the propylene-derived and α-olefin derived units of the propylene-based elastomer.

Embodiment E: The composition of any one of Embodiments B to D, where the first polymer component has an α-olefin content R₁ of from 10 to 25 wt % α-olefin.

Embodiment F: The composition of any one of Embodiments B to E, where the second polymer component has an α-olefin content R₂ of from greater than 2 to less than 8 wt % α-olefin.

Embodiment G: The composition of any one of Embodiments B to F, where the propylene-based elastomer comprises from 1 to 25 wt % of the second polymer component and from 75 to 99 wt % of the first polymer component, based on the weight of the propylene-based elastomer.

Embodiment H: The composition of any one of Embodiments B to G, where the α-olefin of the first reactor component is ethylene.

Embodiment I: The composition of any one of Embodiments B to H, where the α-olefin of the second reactor component is ethylene.

Embodiment J: The composition of any one of Embodiments A to I, where the propylene-based elastomer has a triad tacticity greater than about 75%.

Embodiment K: The composition of any one of Embodiments A to J, where the polyalphaolefin comprises oligomers of α-olefins having from 5 to 24 carbon atoms.

Embodiment L: The composition of any one of Embodiments A to K, where the polyalphaolefin comprises oligomers of 1-octene, 1-decene, 1-dodecene, and blends thereof.

Embodiment M: The composition of any one of Embodiments A to L, where the polyalphaolefin has a kinematic viscosity (KV) at 100° C. of from 500 to 3000 cSt.

Embodiment N: The composition of any one of Embodiments A to M, where the composition comprises 1 to about 40 wt % of the polyalphaolefin and 60 to 99 wt % of the propylene-based elastomer.

Embodiment O: The composition of any one of Embodiments A to N, where the composition comprises 1 to 20 wt % of the polyalphaolefin and 80 to 99 wt % of the propylene-based elastomer.

Embodiment P: The composition of any one of Embodiments A to O, where the composition has two or more of the properties (i) to (vii).

Embodiment Q: The composition of any one of Embodiments A to O, where the composition has three or more of the properties (i) to (vii).

Embodiment R: The composition of any one of Embodiments A to O, where the composition has four or more of the properties (i) to (vii).

Embodiment S: The composition of any one of Embodiments A to O, where the composition has five or more of the properties (i) to (vii).

Embodiment T: The composition of any one of Embodiments A to O, where the composition has six or more of the properties (i) to (vii).

Embodiment U: The composition of any one of Embodiments A to O, where the composition has all of the properties (i) to (vii).

Embodiment V: The composition of any one of Embodiments A to O, where the composition has a first cycle hysteresis top load at 50% strain of less than 25N; a first cycle hysteresis top load at 100% strain of less than 30N; and a first cycle hysteresis retractive force at 50% strain of less than 15N.

Embodiment W: The composition of any one of Embodiments A to V, where the composition has a first cycle hysteresis top load at 50% strain of less than 20 N.

Embodiment X: The composition of any one of Embodiments A to W, where the composition has a first cycle hysteresis top load at 50% strain of less than 15N.

Embodiment Y: The composition of any one of Embodiments A to X, where the composition has a first cycle hysteresis top load at 100% strain of less than 24N.

Embodiment Z: The composition of any one of Embodiments A to Y, where the composition has a first cycle hysteresis top load at 100% strain of less than 18N.

Embodiment AA: The composition of any one of Embodiments A to Z, where the composition has a first cycle hysteresis retractive force at 50% strain of less than 10N.

Embodiment AB: The composition of any one of Embodiments A to AA, where the composition has a first cycle hysteresis top load at 50% strain that is at least 15% lower than a similar composition containing the same PBE but that contains no PAO.

Embodiment AC: The composition of any one of Embodiments A to AB, where the composition has a first cycle hysteresis top load at 50% strain that is at least 30% lower than a similar composition containing the same PBE but that contains no PAO.

Embodiment AD: The composition of any one of Embodiments A to AC, where the composition has a first cycle hysteresis top load at 50% strain that is at least 45% lower than a similar composition containing the same PBE but that contains no PAO.

Embodiment AE: The composition of any one of Embodiments A to AD, where the blend of the polyalphaolefin and the propylene-based elastomer form a droplet morphology such that the polyalphaolefin and the first reactor component of the propylene-based elastomer form sub-inclusions within the second reactor component of the propylene-based elastomer.

Embodiment AF: A film or nonwoven fabric comprising the composition of any one of Embodiments A to AC.

Embodiment AG: A laminate composition having at least one elastic film layer, wherein the elastic film layer comprises the composition of any one of Embodiments A to AF.

Embodiment AH: A laminate composition having at least one elastic film layer, wherein the elastic film layer comprises from about 0.5 to about 60 wt % of a polyalphaolefin and 40 to 99.5 wt % of a propylene-based elastomer, where the propylene-based elastomer comprises propylene-derived units and 5-30 wt % of α-olefin-derived units and where the propylene-based elastomer has a melting temperature of less than 120° C. and a heat of fusion of less than 75 J/g; and where the PAO has a kinematic viscosity (KV) at 100° C. of from 100 to 3000 cSt.

Embodiment AI: The laminate composition of Embodiment AG or AH, wherein the laminate composition further comprises one or more nonwoven facing layers disposed on either side of the elastic layer.

For purposes of convenience, various specific test procedures are identified above for determining certain properties. However, when a person of ordinary skill reads this patent and wishes to determine whether a composition or polymer has a particular property identified in a claim, then any published or well-recognized method or test procedure can be followed to determine that property, although the specifically identified procedure is preferred. Each claim should be construed to cover the results of any of such procedures, even to the extent different procedures can yield different results or measurements. Thus, a person of ordinary skill in the art is to expect experimental variations in measured properties that are reflected in the claims.

Certain embodiments and features have been described using a set of numerical upper limits and a set of numerical lower limits. Ranges from any lower limit to any upper limit are contemplated unless otherwise indicated. All numerical values are “about” or “approximately” the indicated value, and take into account experimental error and variations that would be expected by persons of ordinary skill in the art.

As used herein, the phrases “substantially no,” and “substantially free of” are intended to mean that the subject item is not intentionally used or added in any amount, but may be present in very small amounts existing as impurities resulting from environmental or process conditions.

All patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

We claim:

1. A composition comprising from about 0.5 to about 60 wt % of a polyalphaolefin and 40 to 99.5 wt % of a propylene-based elastomer,
where the propylene-based elastomer comprises propylene-derived units and 5 to 30 wt % of α-olefin-derived units and where the propylene-based elastomer has a melting temperature of less than 120° C. and a heat of fusion of less than 75 J/g;
where the polyalphaolefin has a kinematic viscosity (KV) at 100° C. of from 100 to 3000 cSt; and
where the blend composition has at least one of the following properties:
(i) a first cycle hysteresis top load at 50% strain of less than 25N;
(ii) a first cycle hysteresis top load at 100% strain of less than 30N;
(iii) a first cycle hysteresis retractive force at 50% strain of less than 15N;
(iv) a second cycle hysteresis top load at 50% strain of less than 20N;
(v) a second cycle hysteresis top load at 100% strain of less than 30N;
(vi) a second cycle hysteresis retractive force at 50% strain of less than 12N; or
(vii) a first cycle hysteresis top load at 50% strain that is at least 15% lower than a similar composition containing the same propylene-based elastomer but that contains no polyalphaolefin.

2. The composition of claim 1, where the propylene-based polymer elastomer is a reactor blend of a first polymer component and a second polymer component, wherein the first polymer component comprises propylene and an α-olefin and has an α-olefin content R₁ of from greater than 5 to less than 30 wt % α-olefin, where the percentage by weight is based upon the total weight of the propylene-derived and α-olefin derived units of the first polymer component, and wherein the second polymer component comprises propylene and α-olefin and has an α-olefin content R₂ of from greater than 1 to less than 10 wt % α-olefin, where the percentage by weight is based upon the total weight of the propylene-derived and α-olefin derived units of the second polymer component.

3. The composition of claim 2, where the first polymer component has an α-olefin content R₁ of from 10 to 25 wt % α-olefin.

4. The composition of claim 2, where the second polymer component has an α-olefin content R₂ of from greater than 2 to less than 8 wt % α-olefin.

5. The composition of claim 2, where the propylene-based elastomer comprises from 1 to 25 wt % of the second polymer component and from 75 to 99 wt % of the first polymer component, based on the weight of the propylene-based elastomer.

6. The composition of claim 1, where the propylene-based elastomer has a triad tacticity greater than about 75%.

7. The composition of claim 1, where the polyalphaolefin comprises oligomers of α-olefins having from 5 to 24 carbon atoms.

8. The composition of claim 1, where the polyalphaolefin comprises oligomers of 1-octene, 1-decene, 1-dodecene, and blends thereof.

9. The composition of claim 1, where the polyalphaolefin has a kinematic viscosity (KV) at 100° C. of from 500 to 3000 cSt.

10. The composition of claim 1, where the composition comprises 1 to about 40 wt % of the polyalphaolefin and 60 to 99 wt % of the propylene-based elastomer.

11. The composition of claim 1, where the composition comprises 1 to 20 wt % of the polyalphaolefin and 80 to 99 wt % of the propylene-based elastomer.

12. The composition of claim 1, where the composition has a first cycle hysteresis top load at 50% strain of less than 25N; a first cycle hysteresis top load at 100% strain of less than 30N; and a first cycle hysteresis retractive force at 50% strain of less than 15N.

13. The composition of claim 1, where the composition has a first cycle hysteresis top load at 50% strain of less than 20 N.

14. The composition of claim 1, where the composition has a first cycle hysteresis top load at 50% strain of less than 15N.

15. The composition of claim 1, where the composition has a first cycle hysteresis top load at 100% strain of less than 24N.

16. The composition of claim 1, where the composition has a first cycle hysteresis top load at 100% strain of less than 18N.

17. The composition of claim 1, where the composition has a first cycle hysteresis retractive force at 50% strain of less than 10N.

18. The composition of claim 1, where the composition has a first cycle hysteresis top load at 50% strain that is at least 30% lower than a similar composition containing the same propylene-based elastomer but that contains no polyalphaolefin.

19. The composition of claim 1, where the composition has a first cycle hysteresis top load at 50% strain that is at least 45% lower than a similar composition containing the same propylene-based elastomer but that contains no polyalphaolefin.

20. A film or nonwoven fabric comprising the composition of claim 1.

21. A laminate composition having at least one elastic film layer, wherein the elastic film layer comprises from about 0.5 to about 60 wt % of a polyalphaolefin and 40 to 99.5 wt % of a propylene-based elastomer,
where the propylene-based elastomer comprises propylene-derived units and 5-30 wt % of α-olefin-derived units and where the propylene-based elastomer has a melting temperature of less than 120° C. and a heat of fusion of less than 75 J/g; and
where the polyalphaolefin has a kinematic viscosity (KV) at 100° C. of from 100 to 3000 cSt.

22. The laminate composition of claim 21, wherein the laminate composition further comprises one or more nonwoven facing layers disposed on either side of the elastic layer.
